(19) United States
(12) Patent Application Publication
(10) Pub. No.: US 2024/0228142 A1
(43) Pub. Date: Jul. 11, 2024

(54) ENVIRONMENTALLY FRIENDLY INSULATED PACKING SYSTEM FOR TRANSPORTING FOOD PRODUCTS

(71) Applicant: SEAWISE INNOVATIVE PACKING LTD., Vancouver (CA)

(72) Inventors: Jesse Ronald Knight, Cumberland (CA); James Edwin Scott Williams, Courtenay (CA)

(21) Appl. No.: 18/607,667

(22) Filed: Mar. 18, 2024

Related U.S. Application Data
(63) Continuation-in-part of application No. 18/368,770, filed on Sep. 15, 2023.
(60) Provisional application No. 63/408,142, filed on Sep. 20, 2022.

(51) Int. Cl. B65D 65/46; B65D 65/40; B65D 81/38

(52) U.S. Cl. CPC B65D 65/466; B65D 65/40; B65D 81/3818; B65D 81/3893

(57) ABSTRACT

An environmentally friendly insulated packing system is provided. The insulated packing system may include a base layer, an insulating layer disposed on the base layer in one or more areas and a sealing layer. The insulating layer may be a plurality of block-shaped pockets having a substantially rectangular or cube form in each of the one or more areas. Alternatively, a reflective layer may be included. The base layer may be folded to join the substantially rectangular forms and align with the inner surface of all or part of a shipping container, e.g., a box. In an alternate embodiment, the insulating packing system may be in the form of a bag/pliable pouch.

### RELATED APPLICATION

The following application is a continuation-in-part of and claims priority to U.S. Ser. No. 18/368,770 filed Sep. 15, 2023, which claims priority to U.S. Provisional No. 63/408, 142 filed Sep. 20, 2022, the disclosures of which are incorporated by reference in their entirety.

### FIELD OF THE INVENTION

The present invention relates to an insulated thermal packing system for transporting perishable products such as fresh food products, flowers, and pharmaceuticals, and maintaining such perishable products in a defined or at a required temperature during transport. The insulated packing system may be environmentally friendly, namely replaces the use of expanded polystyrene, may be recyclable, may be biodegradable and in some embodiments may be, derived from a renewable resource (e.g., plants).

### BACKGROUND

Insulated packing for perishable goods when used in combination with refrigerants like ice, frozen gel packs, and the like are generally known. Various materials are also known for such packing such as molded expanded polystyrene foam (EPS), including for example Styrofoam and polyurethane foams. Many jurisdictions are banning or severely restricting the use of EPS as packing material based on environmental concerns including lack of efficient recycling options and EPS not being biodegradable, EPS may also be expensive. And EPS in bead form does not provide a consistent R-value throughout the filled container. There are also non-EPS foams available, however, many of such foams are not waterproof and require plastic wrapping to protect from attack of the foam due to contact with moisture.

Another option in replacing EPS is to utilize insulating liners from foldable cellulosic fibers (i.e., cardboard). Typically such liners provide thermal insulation by utilizing corrugated or honeycomb material between outer sheets. An exemplary liner is provided in U.S. Publication No. US 2017/0327298 A1 to Morasse et al. However, cardboard liners often lack sufficient thermal protection and do not provide waterproofing from ice, and fail to sufficiently maintain the perishable goods in a refrigerated state for prolonged time in shipping. Cardboard is a paper product derived from trees, and may be considered environmentally friendly (biodegradable) compared to EPS. Cardboard, however, is in short supply. There is also an impetus to avoid harvesting trees for paper products particularly from old growth forests. Thus reducing the use of cardboard (and paper) may also be a positive environmental goal.

It is therefore desirable to provide an insulated packing system that has thermal protection properties similar to or better than EPS, but also may have environmentally friendly qualities such as being recyclable, biodegradable, and ideally derived from a material that is from a renewable resource particularly those plants that may regenerate and are harvestable quickly such as corn or sugar cane. In one embodiment, the insulated packing system may be substantially impervious to moisture.

### SUMMARY

An environmentally friendly insulated packing system for perishables is provided. The insulated packing system may include a base layer and an insulating second layer disposed on the base layer in one or more areas. The second layer may be a plurality of block-shaped pockets having a substantially rectangular form in each of the one or more areas. The base layer may be folded to join the substantially rectangular forms and align with the inner surface of all or part of a packing or shipping container, e.g., a box. In one embodiment a sealing layer may be included to provide a further air trap and thus additional insulation. The sealing layer is also a barrier against moisture. In an alternate embodiment, the insulating packing system may be in the form of a bag or pouch.

In operation, the insulating packing system may be designed such that the block-shaped pockets facilitate air being trapped between the pockets to create an additional insulating layer around the perishables. The material for the base layer, and insulating layer may also be impervious to water such that moisture does not adversely affect the insulating materials. A sealing layer may be added to provide additional air entrapment and provide an additional barrier against moisture. Additionally, a reflective layer may be included to provide additional insulating properties.

### BRIEF DESCRIPTION OF THE DRAWINGS

Exemplary embodiments are illustrated in the referenced figures of the drawings. It is intended that the embodiment and figures disclosed herein be illustrative rather than limiting.

FIG. 1 illustrates a perspective view of an example of a packing system including an arrangement of insulating sheets and showing the top insulating sheet open.

FIG. 2 illustrates a perspective view of an example of a packing system including an arrangement of insulating sheets and showing the top insulating sheet closed.

FIG. 3 illustrates a perspective view of an example of an arrangement of insulating sheets of the packing system of the disclosure.

FIGS. 4A and 4B illustrates a plan view and a cross-sectional view of an example of an insulating sheet of the packing system of the disclosure.

FIG. 5 is a plan view showing the packing system being inserted in a container.

FIG. 6 is a plan view showing the packing system lid in a closed position.

FIG. 7 is a plan view showing the container lid including the packing system in an open and closed position for shipping.

FIG. 8 illustrates a perspective view of an alternative embodiment in which the insulating sheets of the packing system of the disclosure are arranged as a bag/pouch.

FIG. 9 illustrates a cross-sectional view of an example of a bag/pouch of the disclosure prior to folding.

FIG. 10 illustrates a cross-sectional view of an example of an insulating sheet of the disclosure prior to folding.

FIGS. 11A, 11B and 11C are plan views showing a section of the packing system wrapped in a sealing layer.

FIGS. 12A, 12B and 12C are plan views showing an alternative embodiment of the packing system insert including a reflective layer with the insert prior to folding (FIG. 12A), folded (FIG. 12B) and inserted in a container (FIG. 12C).

FIG. 13 is a plot of temperature (° C.) versus time comparing the invention packing system with an EPS-based packing system for the interior temperature of the packing system.

FIG. 14 is a plot of temperature (° C.) versus time comparing the invention packing system with an EPS-based packing system for the temperature of a fish in the packing system.

FIG. 15 is a plot temperature (° C.) versus time comparing the invention packing system with a reflective layer with an EPS-based packaging system and with hexacombed cardboard for the interior temperature of the packaging system.

### DETAILED DESCRIPTION

Several embodiments will be described more fully in reference to the accompanying figures. However, this disclosure should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

The terminology used herein is for the purposed of describing particular embodiments only and is not intended to be limiting of the invention. As used herein, the singular forms “a”, “and”, and “the” are intended to include the plural forms as well, unless the context clearly indicates otherwise.

It will be understood that when an element is referred to as being “attached,” “coupled” or “connected” to another element, it can be directly attached, coupled or connected to the other element or intervening elements may also be present. In contrast, when an element is referred to as being “directly attached,” “directly coupled” or “directly connected” to another element, there are no intervening elements present.

All patents, patent applications and publications referred to herein are incorporated by reference in their entirety. In case of a conflict in terminology, the present specification is controlling.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

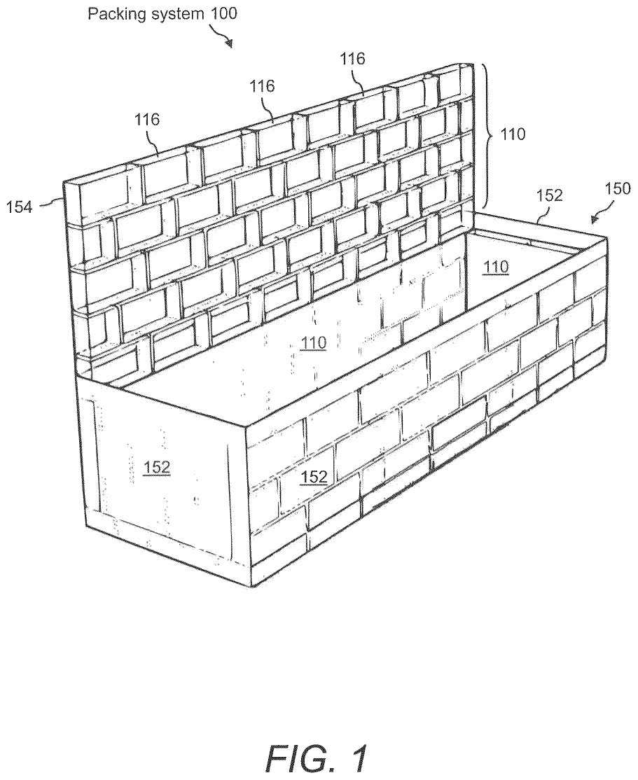

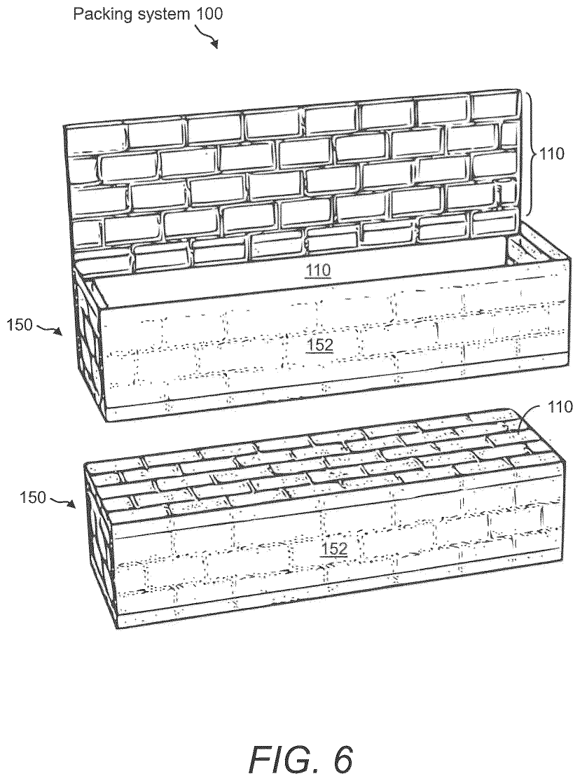

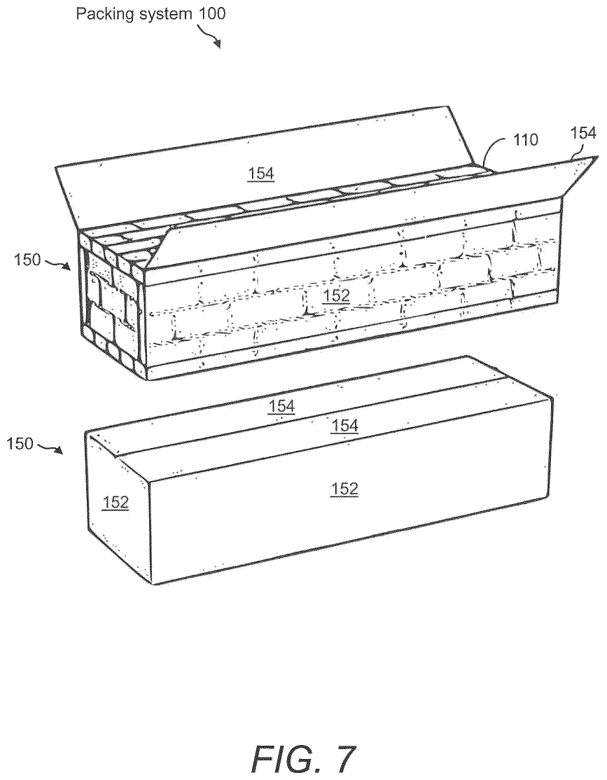

The present invention provides a packing system 100 and is shown in FIGS. 1-12C. The packing system provides thermal insulation for perishable products. Exemplary perishable products include seafood, shellfish, meat and meat products, vegetables, flowers, fresh and dried herbs, fruits, alcoholic and non-alcoholic liquids, pharmaceuticals, nutraceuticals and other perishable medical items such as blood, organs, tissues, medical specimens, and the like.

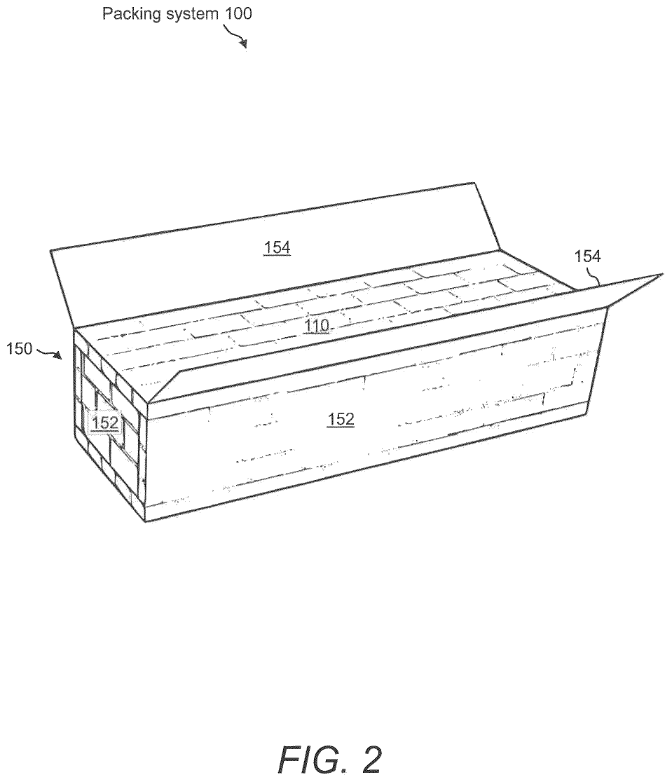

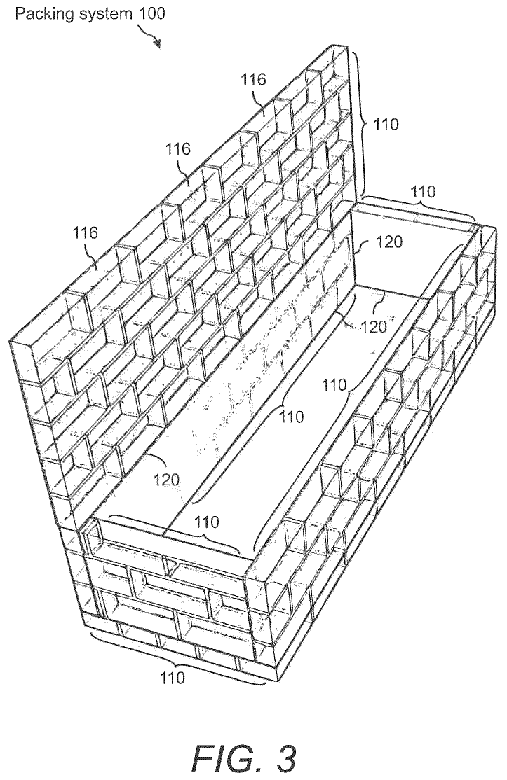

Referring to FIG. 1 and FIG. 2, a packing system 100 according to one embodiment of the present disclosure is shown. The packing system 100 may include an arrangement of insulating sheets 110 including pockets 116. The packing system 100 may be sized and configured to be inserted into a container 150 such as, for example, a box or other appropriate shipping container, and may also include side panels 152, a top flap 154 and a bottom panel (not shown). Referring to FIG. 3, the insulating sheets 110 may be folded at folds 120 to conform to placement in a container.

It is noted that the embodiments illustrated in FIGS. 1-3 show a fold 120 or hinge of what may be considered as a top or a lid. In some embodiments the lid may be detached from the rest of the box. This configuration may often be utilized when the box or other appropriate shipping container is loaded with ice to facilitate the placement of ice in the box.

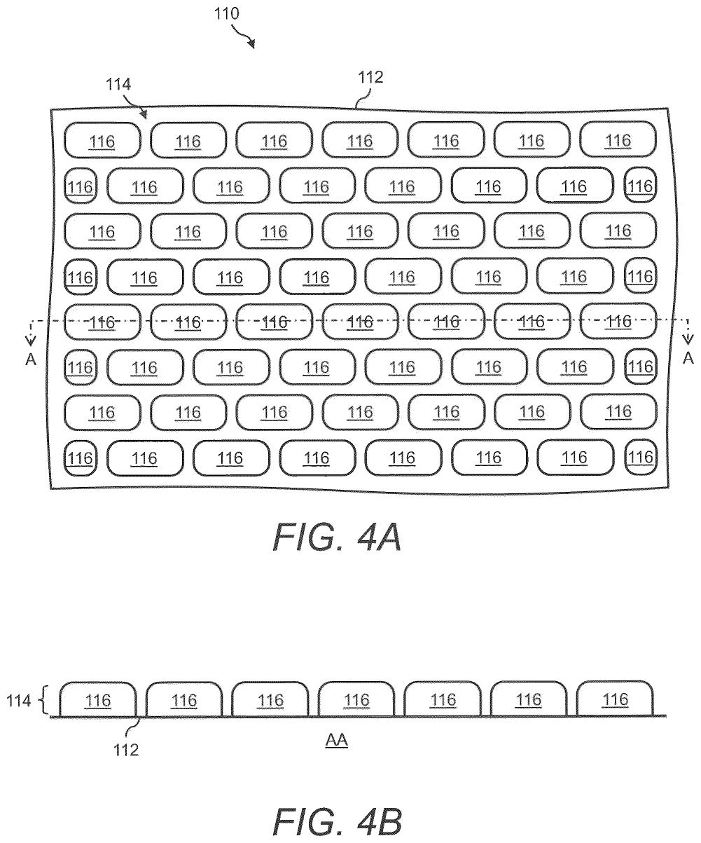

In FIG. 4A, a cross-sectional view of one example of insulating sheets 110 and exemplary embodiments of pockets 116 are provided. FIG. 4B presents another cross-sectional view taken along line A-A of FIG. 4A. The insulating sheets 110 may include a base layer 112 and an insulation layer 114. The insulating layer 114 may include insulation layer pockets 116. The insulation layer pockets 116 may be block-like, for example, generally rectangular or cubed in shape, although the selection of the specific shape of the insulation layer pockets 116 may be varied as desired for different applications and/or configurations. The pockets 116 form air traps to provide additional insulation. The pockets are in contrast to bubble wrap in which air entrapment may be an issue.

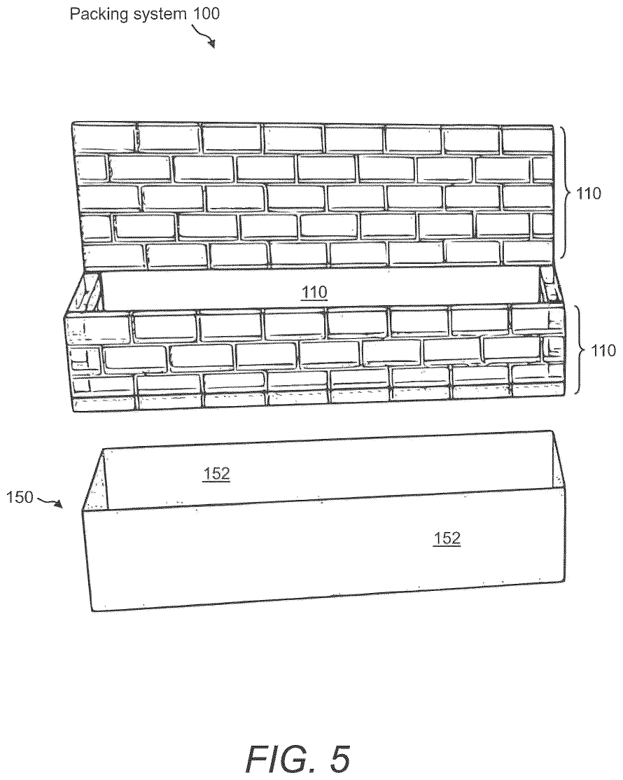

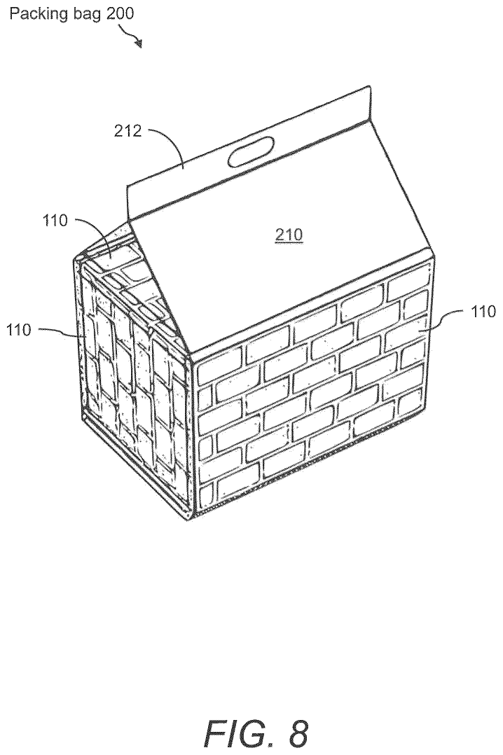

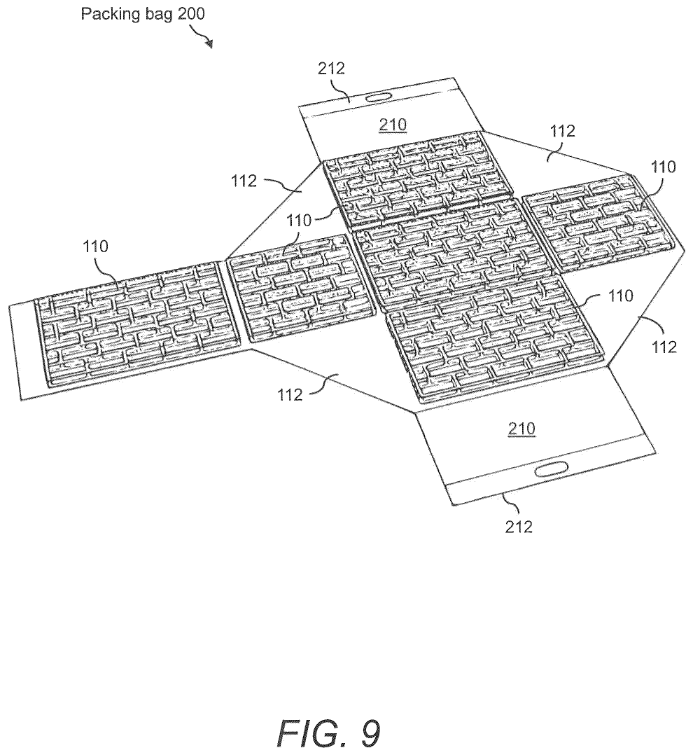

Referring to FIGS. 5-7, an exemplary process of using the packing system 100 of an embodiment of the disclosure is illustrated. In some embodiments, the packing system may be folded to provide a box-shaped construction (FIG. 8), which then may be placed in a container 150 and the box flaps closed (FIG. 9).

As shown in FIG. 8, in an alternate embodiment, the packing system may be in the form of a packing bag or pliable pouch 200. The bag/pouch 200 may include the insulating sheets 110 formed into a bag shape and include a top portion 210 and a handle 212 to hold the folded insulating sheets 110 together. FIG. 9 illustrates the bag/pouch exemplary embodiment. The insulating layers 110 may be folded with base layers 112 and 210 into the desired bag/pouch form with a handle 212.

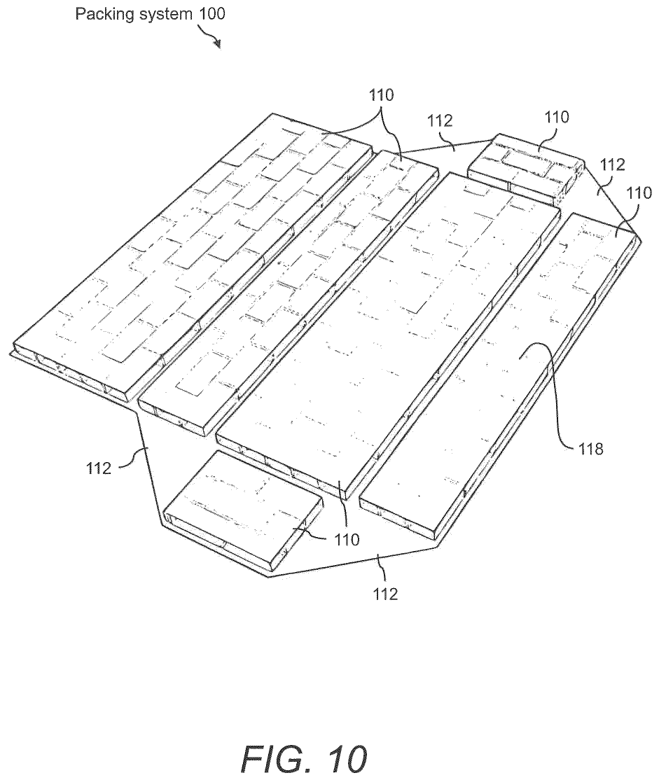

FIG. 10 illustrates an exemplary embodiment of the packing system 100 prior to folding. The insulating sheets 110 may include the base layer 112 and the insulating layers 114. The insulating sheets 110 may be folded along fold lines 120 to assemble the packing system 100 into a desired form, including for example a three-dimensional box-shaped form appropriate for insertion into a shipping container or other desired container, among other things.

The insulating layer may be waterproof, and provide insulating R-values comparable to EPS materials such as Styrofoam. For example, the insulating sheets may have an R-value comparable to one-inch thick Styrofoam of 3.6 to 4.2 (still air has an R-value of 3.6 per inch of thickness).

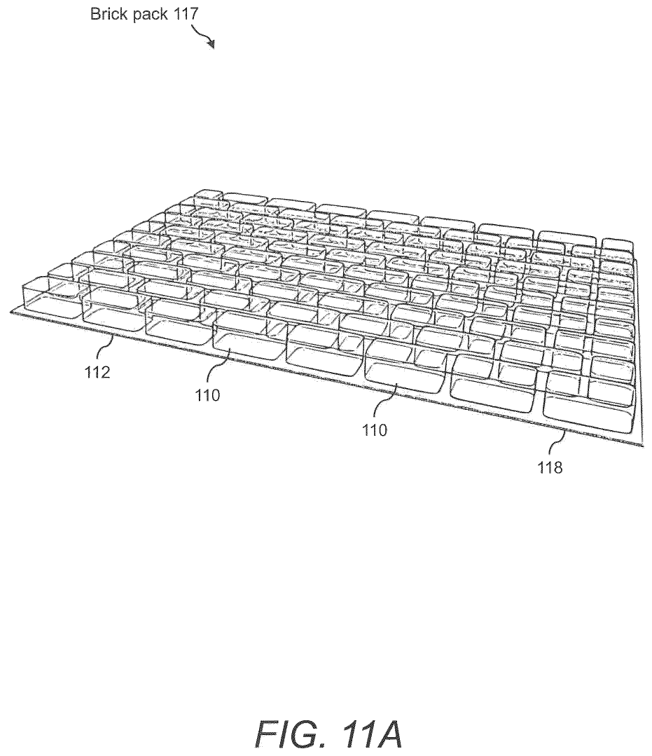

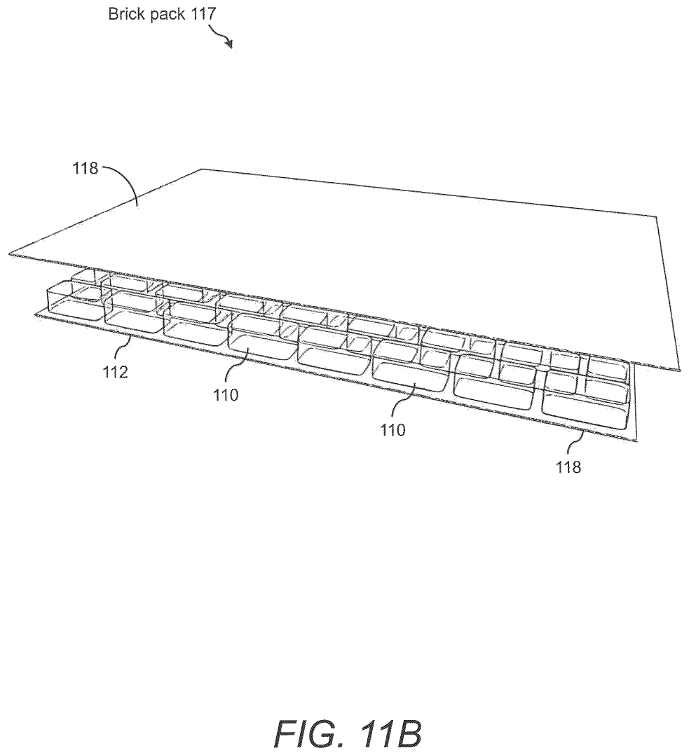

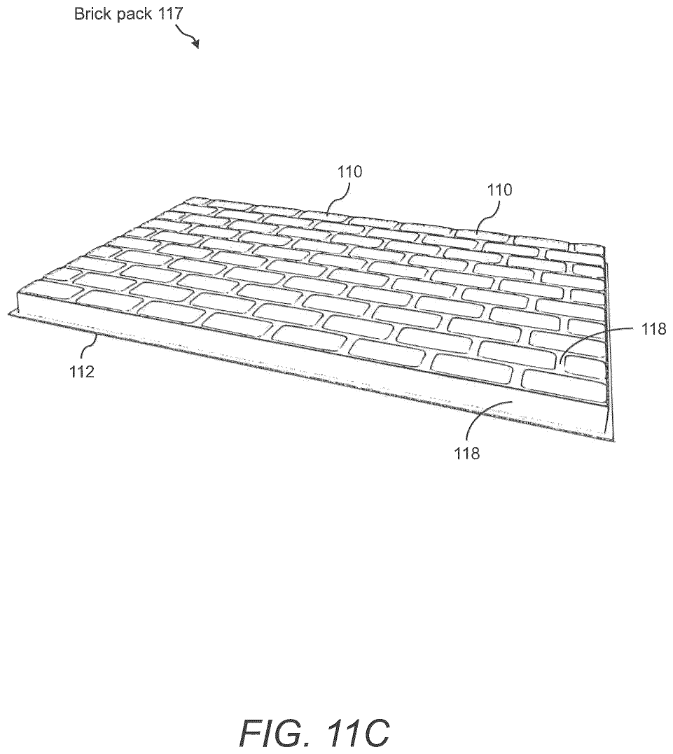

In an alternative embodiment, the insulating sheets may be wrapped or covered by a sealing layer 118. Referring to FIGS. 11A, 11B, and 11C, each section 117 of the packing system 110 may be wrapped or covered with a sealing layer 118 such that the base layer 112 and insulating layer 114 are encased or enveloped by the sealing layer 118 (See FIG. 11C). By sealing each of the insulating sheets, the sealing layer 118 may facilitate air entrapment between the packets 116 of the insulating sheets 110, and provide an additional layer resistant to water and moisture. A reflective layer may also be included.

The sealing layer 118 may also be derived from or include a metallized polymer such as metallized polyester or polyethylene. Metallized polyethylene may act as a temperature resistant layer in that thermal heat is reflected. Thus, in the combination of the insulation layer, the sealing layer and the reflective layer, the metallized reflective layer may act as both an insulating and thermal barrier. Typically the metallized polyethylene may be prepared by laminating or coating aluminum on a low density polyethylene film. The sealing layer and the reflective layer may be formed as a single layer or may be separate layers.

The insulating sheets 110 may be derived from a wide variety of polymers that are more environmentally and economically friendly as compared to EPS. Exemplary polymers may include conventional polymers utilized for bubble-wrap such as a polyethylene. In one embodiment, low density polyethylene (LDPE) may be utilized. The LDPE may be derived from recycled materials.

The insulating sheets 110 may in another embodiment be derived from a renewable and sustainable resource such as plants. The insulating sheets 110 may further be recyclable and/or compostable, and provide a low carbon footprint. The base layer, insulating layer, sealing and/or reflective layer may be derived from a renewable resource that may be compostable. Exemplary plant-based polymers include polylactic acid (PLA), biopolyethylene (PE), biopolyethylene terephthalate (PET), polybutylene adipate terephthalate (PBAT), polycaprolactone and the like. Naturally-derived pulps including lignin may also be used. In one embodiment, the biopolyethylene may be a compostable hemp-based linear low density polyethylene. The sealing layer and/or reflective layer may be the same material as the base layer or insulating layer.

Alternatively, the base layer and insulating layer may be derived form a nano-starch compound mixed with a biodegradable polymer such as polylactic acid, polybutylene terephthalate (PBT), polyhydroxy alkanoates (PHA), polybutylene adipate terephthalate (PBAT), polybutylene succinate (PBS), and polycaprolactone (PCL). Such a nano-starch compound mixed with a biodegradable polymer is described, for example, in U.S. Patent Application Publication No. 2021/0309848 A1 to Planeta et al. the disclosure of which is incorporated by reference in its entirety. These biodegradable polymers may be derived from renewable resources or may be derived from conventional oil-based and gas-based sources.

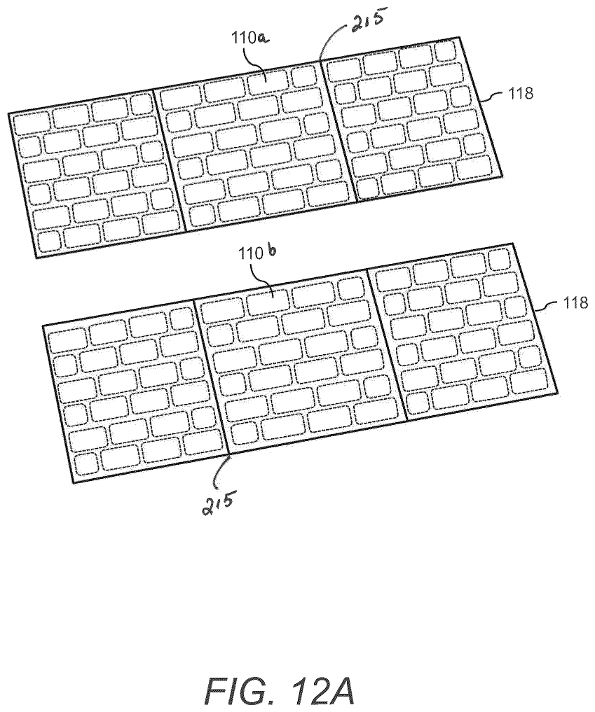

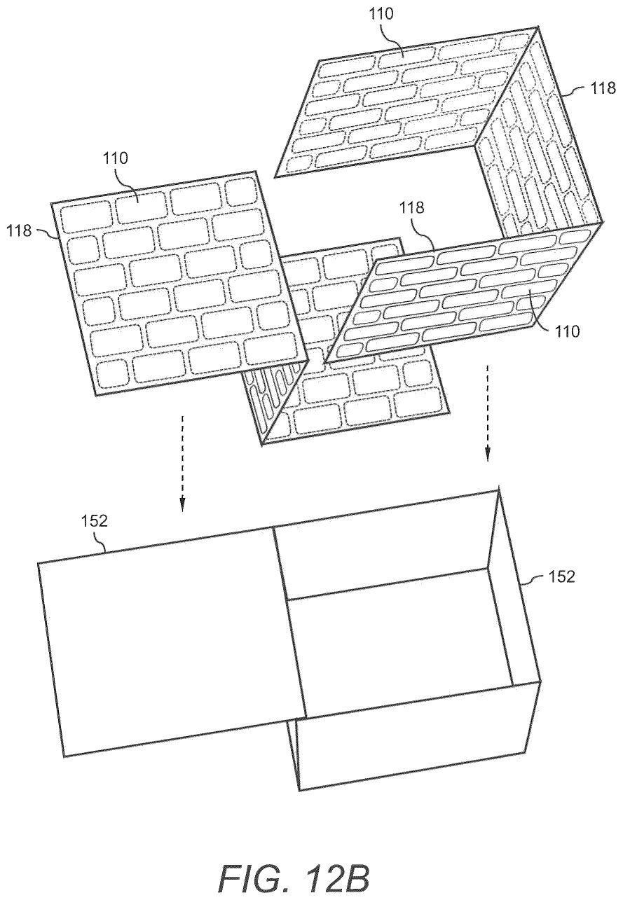

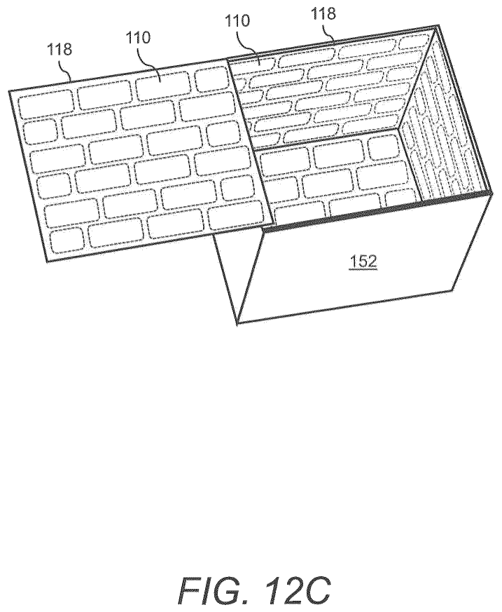

FIGS. 12A-12C illustrate an embodiment in which the insulating sheet 110 including a sealing layer and a reflective layer are provided in a flat configuration with two fold lines. Such a configuration allows the packing system to be shipped in a flat configuration and allows for shipping in bulk. As shown in FIG. 12A, each insulating layer 110a, 110b are folded along the fold lines 215 and positioned in the container 152 (FIGS. 12B and 12C) with the sealing layer facing the inner portion of the box. By utilizing a reflective material improved thermal properties may be provided.

The following examples are intended to illustrate certain embodiments of the present invention, but do not exemplify the full scope of the invention.

### EXAMPLE 1

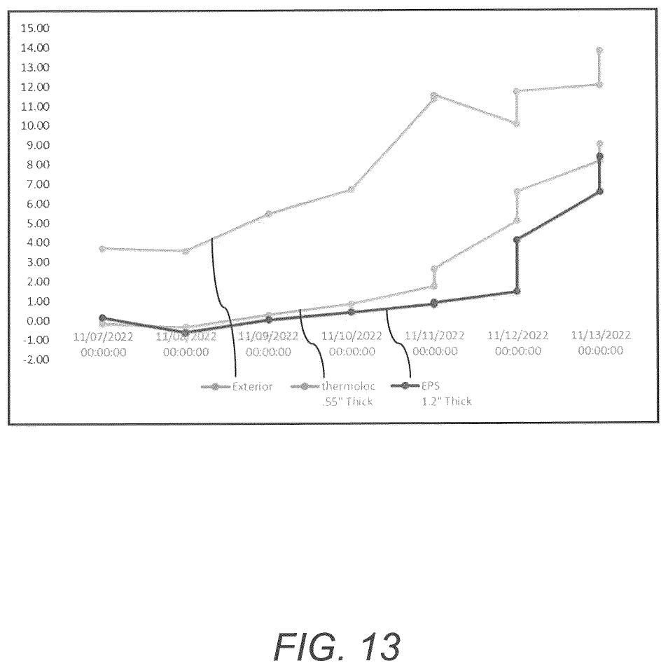

An insulating liner of the invention comprising low density polyethylene (LDPE) is compared to a liner comprising EPS. The insulating packing system of invention has a thickness of 0.14 mm and the EPS liner has a thickness of 30.5 mm. The outside temperature and the inside temperature of the box and a fish placed in the box are measured. The rise in temperature over 144 hours is plotted in 24-hour increments. The results are shown in FIG. 12 (box) and FIG. 13 (fish). The insulating packing system of the invention perform equally or better than the EPS-based packaging and does so with a system having a reduced thickness as compared to EPS-based packaging.

### EXAMPLE 2

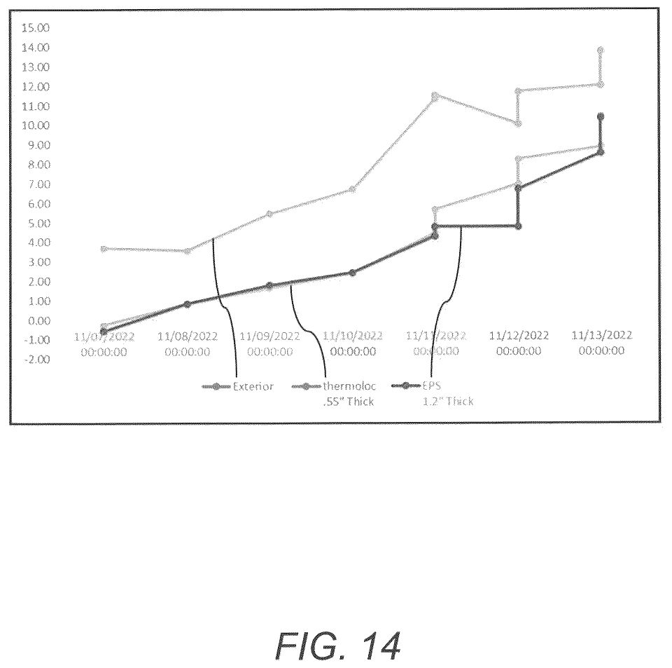

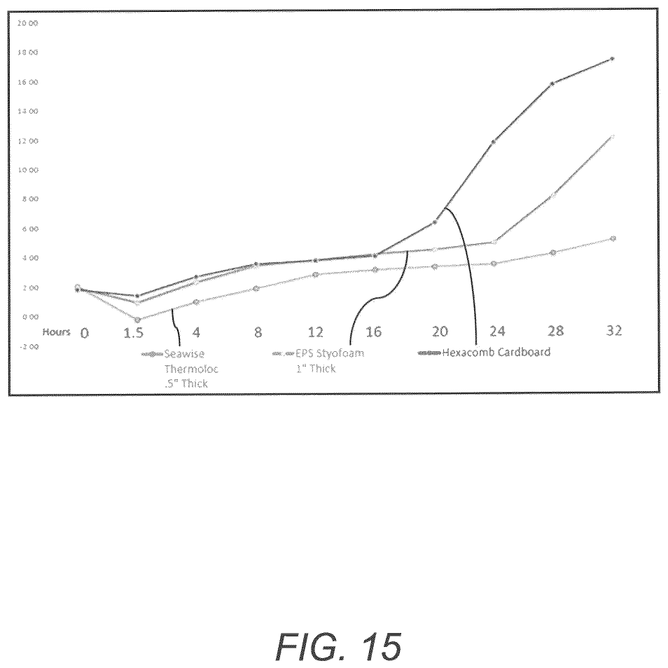

An insulating liner of the invention comprising low density polyethylene (LDPE) is compared to an EPS-based liner and a hexacomb cardboard liner. The insulating packing system of invention has a thickness of 014 mm with a 1 mm layer of metallized polyethylene, the EPS-based liner has a thickness of 25.4 mm, and the hexacomb cardboard liner has a thickness of 12.7 mm. The outside temperature and the inside temperature of the box are measured. The rise in temperature over 144 hours is plotted in 24-hour increments. The results are shown in FIG. 14 (box) and FIG. 15 (fish). The insulating packing system of the invention perform equally or better than the EPS-based packaging or hexacomb cardboard and does so with a system having a reduced thickness as compared to EPS-based packaging.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed is:

1. A packing system comprising:
a base layer; and
an insulating layer disposed on the base layer in one or more areas;
wherein the insulating layer comprises a plurality of block-shaped pockets taking a substantially rectangular or cube form in each of the one or more areas and creates air traps for insulation;
and further wherein the base layer is folded to join the substantially rectangular or cube forms in each of the one or more areas to align with the inner surface area of all or part of a shipping container.

2. The packing system of claim 1, wherein the base layer and the insulating layer are derived from a renewable resource.

3. The packing system of claim 1, wherein the base layer and the insulating layer are derived from a waterproof biodegradable polymer.

4. The packing system of claim 1, wherein the base layer and the insulating layer are derived from polyethylene.

5. The packing system of claim 1 in the form of a bag or pliable box.

6. A packing system comprising a base layer, an insulating layer disposed on the base layer in one or more areas, and a sealing layer, wherein the insulating layer comprises a plurality of block-shaped pockets taking a substantially rectangular form in each of the one or more areas and a shipping container with the base layer and insulating placed in the container, wherein the base layer is folded to join the substantially rectangular forms in each of the one or more areas to align with the inner surface area of all or part of the containers.

7. The packing system of claim 6, wherein the base layer, the insulating layer and/or sealing layer are derived from a renewable resource.

8. The packing system of claim 6, wherein the base layer, the insulating layer and/or sealing layer are derived from a biodegradable polymer.

9. The packing system of claim 7, wherein the base layer and the insulating layer are derived from polyethylene.

10. A packing system comprising:
a base layer;
an insulating layer disposed on the base layer in one or more areas, and;
a sealing layer covering the base layer and insulating layer;
wherein the at least one insulating layer comprises a plurality of block-shaped pockets taking a substantially rectangular or cube form in each of the one or more areas and creates air traps for insulation.

11. The packing system of claim 10, wherein the base layer, the insulating layer and/or sealing layer are derived from a renewable resource.

12. The packing system of claim 10, wherein the base layer, the insulating layer and/or the sealing layer are derived from a waterproof biodegradable polymer.

13. The packing system of claim 10, further comprising a reflective layer.

14. The packing system of claim 13, wherein the reflective layer is metallized polyethylene film.

15. The packing system of claim 10 in the form of a bag or pouch.

16. A packing system comprising a base layer, an insulating layer disposed on the base layer in one or more areas, a sealing layer sealing the base layer and the insulating layer, and a reflective layer, wherein the insulating layer comprises a plurality of block-shaped pockets taking a substantially rectangular form in each of the one or more areas, and a shipping container, with the base layer, the insulating layer, the sealing layer and reflective layer, placed in the container.

17. The packing system of claim 16, wherein the base layer, the insulating layer and/or the sealing layer are derived from a renewable resource.

18. The packing system of claim 16, wherein the reflective layer is metallized polyethylene film.
